(19) United States
(12) Patent Application Publication
(10) Pub. No.: US 2006/0098267 A1
(43) Pub. Date: May 11, 2006

(54) Variable mirror

(75) Inventor: Tsuyoshi Togawa, Hachioji-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 11/292,676

(22) Filed: Dec. 2, 2005

Related U.S. Application Data
(63) Continuation of application No. PCT/JP04/07640, filed on May 27, 2004.

(30) Foreign Application Priority Data
Jun. 9, 2003 (JP) 2003-163925

(51) Int. Cl. G02B 26/00

(52) U.S. Cl. 359/291

(57) ABSTRACT

A variable mirror accurately mountable and capable of maintaining constant an optical path, comprising a first substrate having a reflective part reflecting light and a second substrate opposed to the first substrate and having portions for changing at least one of the shape and attitude of the reflective part. The second substrate further comprises a mounting area for a mounted member formed on the side of the second substrate opposed to the first substrate.

### CROSS-REFERENCE TO RELATED APPLICATIONS

This is a Continuation Application of PCT Application No. PCT/JP2004/007640, filed May 27, 2004, which was published under PCT Article 21(2) in Japanese.

This application is based upon and claims the benefit of priority from prior Japanese Patent Application No. 2003-163925, filed Jun. 9, 2003, the entire contents of which are incorporated herein by reference.

### BACKGROUND OF THE INVENTION

1. Field of the Invention

The present invention relates to a variable mirror, and in particular, to a variable mirror used to correct for example, image blur in an image capture apparatus (camera shake).

2. Description of the Related Art

Jpn. Pat. Appln. KOKAI Publication No. 2002-214662 proposes a variable mirror having a reflection surface the tilt angle of which is varied by an electrostatic force, as means for correcting image blur in an image capture apparatus. Jpn. Pat. Appln. KOKAI Publication No. 11-258678 discloses an image capture apparatus having a bending optical system in a lens barrel module.

### BRIEF SUMMARY OF THE INVENTION

A variable mirror according to a first aspect of the present invention comprises a first substrate having a reflection portion which reflects light and a second substrate located opposite the first substrate and having a part used to vary at least one of a shape and a position of the reflection portion, wherein the second substrate has an attachment area on a surface of the second substrate, which is located opposite the first substrate.

A variable mirror according to a second aspect of the present invention comprises a first substrate having a reflection portion which reflects light and a second substrate located opposite the first substrate, the variable mirror being configured so that the first substrate and the second substrate interact with each other, wherein the second substrate has a projecting portion on a surface of the second substrate, which is located opposite the first substrate.

### BRIEF DESCRIPTION OF THE SEVERAL VIEWS OF THE DRAWING

FIG. 1 is a perspective view schematically showing the external configuration of an image capture apparatus in accordance with first and second embodiments of the present invention.

FIG. 2 is a block diagram showing the configuration of the image capture apparatus in accordance with the first and second embodiments of the present invention.

FIG. 3 is a diagram illustrating the principle of image blur correction in the image capture apparatus in accordance with the first and second embodiments of the present invention.

FIG. 4 is a diagram showing an example of the configuration of a variable mirror in accordance with the first embodiment of the present invention.

FIGS. 5A and 5B are diagrams showing an example of arrangement of electrodes in the variable mirror in accordance with the first embodiment of the present invention.

FIG. 6 is a diagram showing how the variable mirror in accordance with the first embodiment of the present invention is attached.

FIG. 7 is a sectional view showing an example of the configuration of a variable mirror in accordance with the second embodiment of the present invention.

FIG. 8 is a perspective view showing an example of the configuration of the variable mirror in accordance with the second embodiment of the present invention.

FIGS. 9A to 9E are sectional views showing an example of a method for manufacturing the variable mirror in accordance with the second embodiment of the present invention.

FIG. 10 is a diagram showing how the variable mirror in accordance with the second embodiment of the present invention is attached.

FIG. 11 is a perspective view showing another example of the configuration of the variable mirror in accordance with the second embodiment of the present invention.

FIG. 12 is a perspective view showing an example of the configuration of a lower substrate in the variable mirror in accordance with the first embodiment of the present invention.

FIG. 13 is a perspective view of a variation of the variable mirror in accordance with the first embodiment of the present invention.

FIG. 14 is a perspective view of a variation of the variable mirror in accordance with the first embodiment of the present invention.

FIG. 15 is a perspective view of a variation of the variable mirror in accordance with the first embodiment of the present invention.

FIGS. 16A and 16B are diagrams showing positions at which springs are arranged in accordance with the first embodiment of the present invention.

FIGS. 17A and 17B are diagrams showing a variation of the variable mirror in accordance with the first embodiment of the present invention.

### DETAILED DESCRIPTION OF THE INVENTION

Embodiments of the present invention will be described below with reference to the drawings.

### First Embodiment

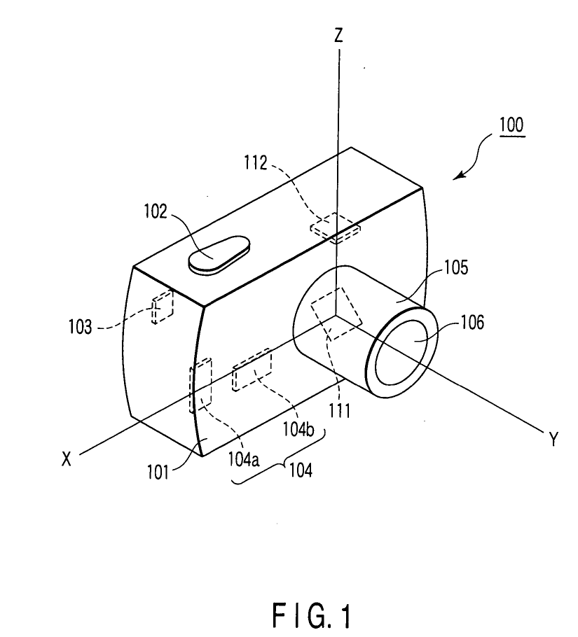

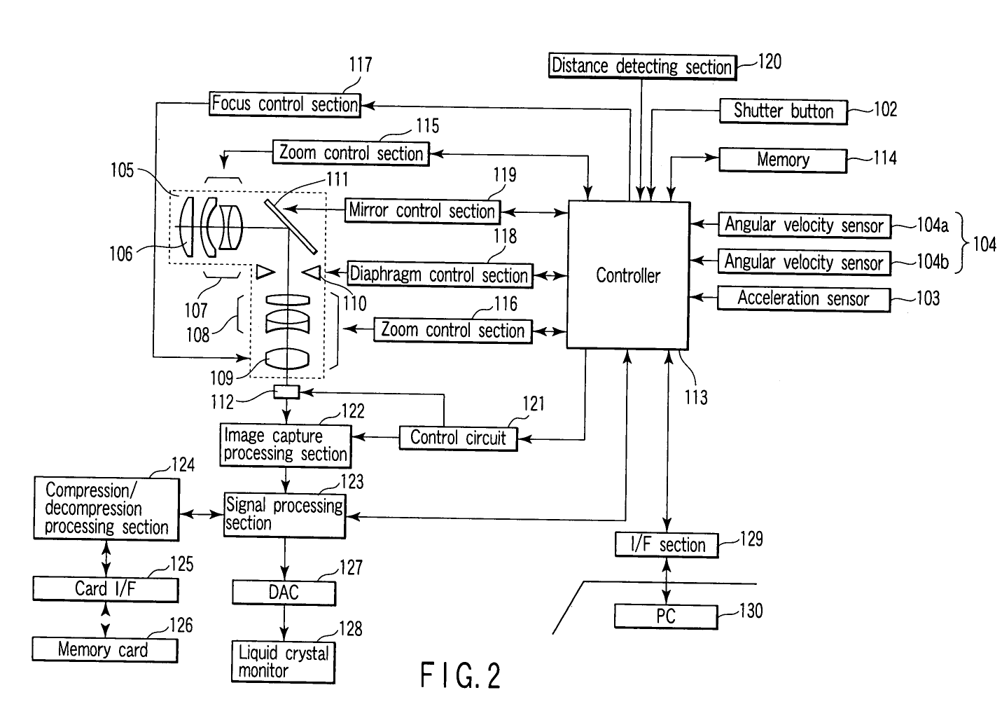

FIG. 1 is a perspective view schematically showing the external configuration of a digital camera (image capture apparatus) in accordance with a first embodiment of the present invention. FIG. 2 is a block diagram showing the configuration of the digital camera in accordance with the first embodiment.

A shutter button 102 is provided at the top of a main body 101 of a digital camera 100. A three-axis acceleration sensor 103 and an angular velocity sensor 104 (including sensors 104a and 104b) are provided inside the main body 101; the three-axis acceleration sensor 103 detects a translation component of motion and the angular velocity sensor 104 detects a rotation component of motion.

A lens barrel module 105 is provided with a first group lens 106, a second group lens 107, a third group lens 108, a fourth group lens 109, a diaphragm 110, and a variable mirror 111. Light for a subject image passes through the first group lens 106 and second group lens 107 and is then reflected by the variable mirror 111. The light further passes through the third group lens 108 and fourth group lens 109 and is then formed into the subject image on a CCD (imaging device) 112. CCD 112 photoelectrically converts the resulting subject image into an electric signal. An optical axis traveling from the first group lens 106 to the variable mirror 111 corresponds to a Y axis shown in FIG. 1. An optical axis traveling from the variable mirror 111 to CCD 112 corresponds to a Z axis.

A controller 113 controls the whole digital camera. A control program is pre-stored in ROM in a memory 114. The memory 114 also includes RAM used as a working storage area when the control program is executed.

A zoom control section 115 controls the second group lens 107 on the basis of instructions from the controller 113. A zoom control section 116 controls the third group lens 108 and the fourth group lens 109 on the basis of instructions from the controller 113. These control operations adjust the angle of view. A focus control section 117 drives the fourth group lens 109 on the basis of instructions from the controller 113 for focusing. A diaphragm control section 118 controls the diaphragm 110 on the basis of instructions from the controller 113.

A mirror control section 119 varies the tilt angle of a reflection surface of the mirror 111 on the basis of instructions from the controller 113. The tilt angle is controlled on the basis of output signals from the three-axis acceleration sensor 103 and the angular velocity sensor 104. The present digital camera 100 also comprises a distance detecting section 120 that detects the distance to the subject. Distance information form a distance detecting section 120 is also used to control the tilt angle. Image blur during image capturing is corrected by thus controlling the tilt angle of the mirror 111. This will be described below in detail.

A control circuit 121 controls CCD 112 and an image capture processing section 122 on the basis of instructions from the controller 113. The image capture processing section 122 includes a CDS (Correlated Double Sampling) circuit, an AGC (Automatic Gain Control) circuit, and ADC (Analog to Digital Converter). The image capture processing section 122 executes a predetermined process on an analog signal output by CCD 112 and converts the processed analog signal into a digital signal.

The signal processing section 123 executes a process such as white balancing or γ correction on image data output by the image capture processing section 122 or a compression/decompression processing section 124. The signal processing circuit 123 also includes an AE (Automatic Exposure) detection circuit or an AF (Automatic Focus) detection circuit.

The compression/decompression processing section 124 executes a compressing process and a decompressing process on image data. The compression/decompression processing section 124 executes a compressing process on image data output by the signal processing section 123 and a decompressing process on image data output by a card interface (I/F) 125. The compressing process and the decompressing process are executed on image data using for example, a JPEG (Joint Photographic Experts Group) system. The card I/F 125 enables transmissions between the present digital camera 100 and a memory card 126. The card I/F 125 writes and reads image data. The memory card 126 is semiconductor recording media for data recording. The memory card 126 can be installed in and removed from the present digital camera 100.

DAC (Digital to Analog Converter) 127 converts a digital signal (image data) output by the signal processing section 123, into an analog signal. A liquid crystal display monitor 128 displays an image on the basis of the analog signal output by DAC 127. The liquid crystal display monitor 128 is provided on a rear surface of the camera main body 101. A user can capture an image while viewing the liquid crystal display monitor 128.

An interface section (I/F section) 129 enables transmissions between the controller 113 and a personal computer (PC) 130. The interface section 129 is for example, an interface circuit for USB (Universal Serial Bus). When the present digital camera is manufactured, the personal computer 130 is used to write data required to correct the focus sensitivity of CCD 112, to the memory 114 and to pre-provide the mirror control section 119 with various data. Accordingly, the personal computer 130 does not constitute the present digital camera 100.

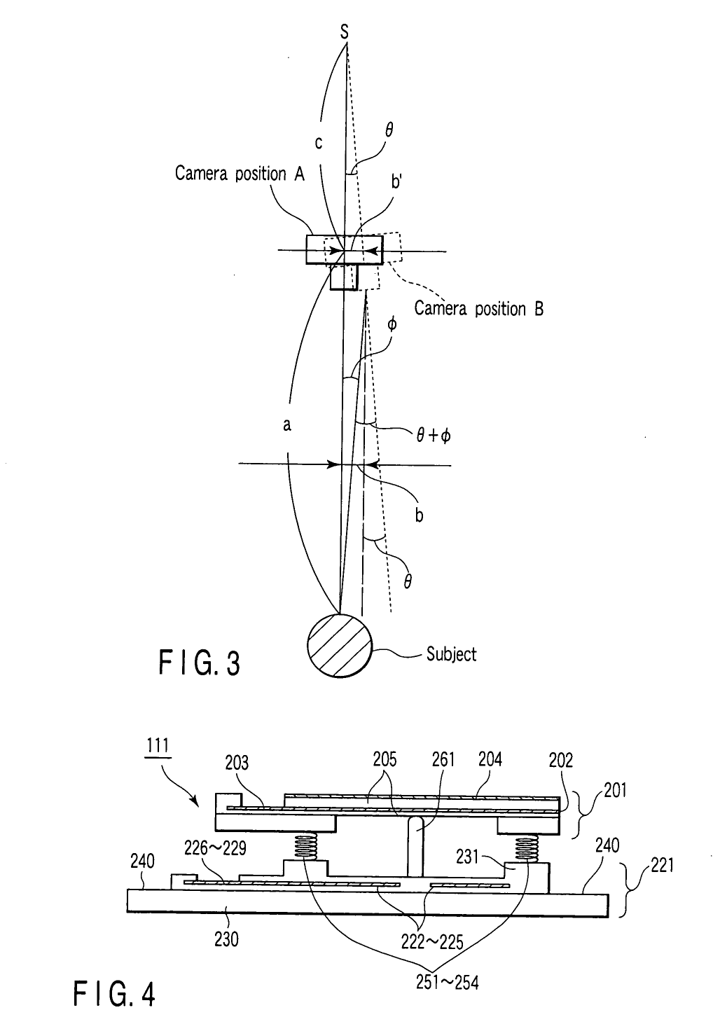

Now, with reference to FIG. 3, description will be given of the principle of image blur correction in the present digital camera.

In FIG. 3, it is assumed that the digital camera is swung from a camera position A to a camera position B around a reference point S (for example, the position of the user's shoulder) within a predetermined time of exposure. In this case, a swing angle θ is determined by integrating output signals from the angular velocity sensor 104. However, since the swing center (reference point S) is located away from the camera, the angle θ is smaller than that to be actually corrected. It is thus necessary to add the angle θ to an angle φ to determine an angle (θ+φ).

The angle φ can be determined as described below. If θ is sufficiently small, it is possible to determine a movement b′ approximate to the movement b, in the X axis direction, of the central position of the camera by twice integrating output signals for the X axis direction (see FIG. 1) of the three-axis acceleration sensor 103. The distance detecting section 120 can determine the distance a from the camera to the subject. Once the movement b′ and the distance a are found, the angle φ can be determined from arctan(b′/a). By thus finding the actually required corrected angle (θ+φ), it is possible to determine the corrected tilt angle for the mirror 111. The image blur can thus be corrected appropriately.

The distance a to the subject can be determined by an auto focus operation performed before the start of image capturing. Further, if detection is carried out at a sampling rate of for example, 2 kHz, sampling interval is 0.5 milliseconds. The rotation amount 0 during 0.5 milliseconds is sufficiently small. This enables the above correction process to be achieved sufficiently precisely.

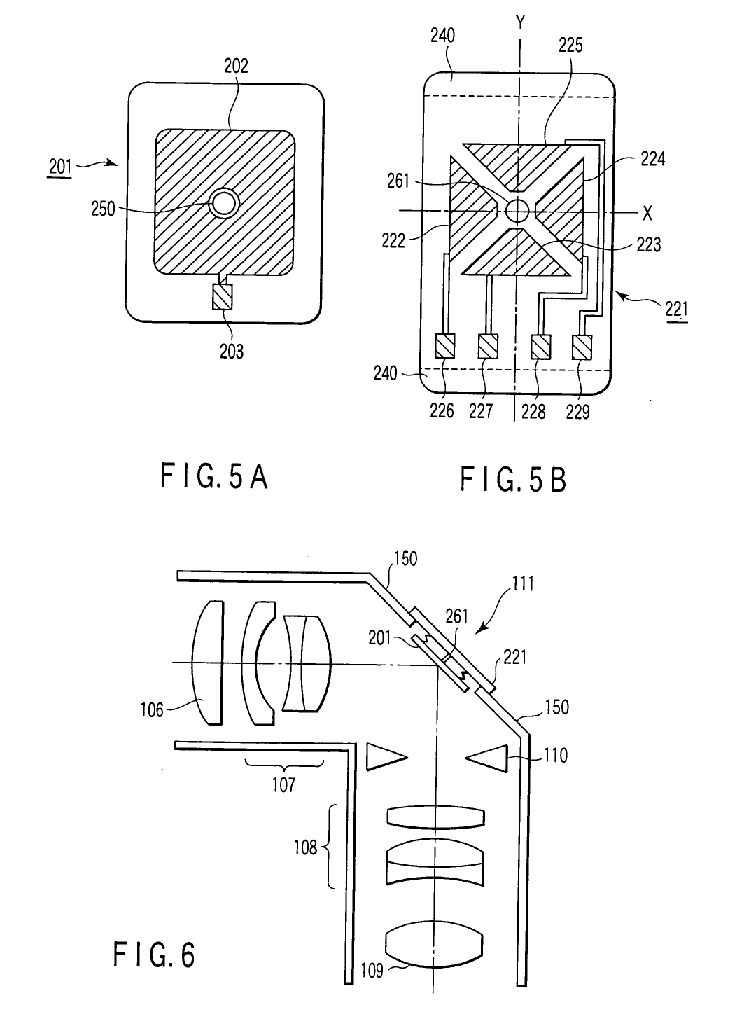

FIG. 4 is a diagram showing an example of the configuration of the variable mirror 111 in accordance with the present embodiment. FIGS. 5A and 5B are diagrams showing an example of an electrode arrangement in the variable mirror 111. The variable mirror 111 shown in FIGS. 4, 5A, and 5B is produced using what is called a MEMS (Micro Electro-Mechanical System) technique to which a semiconductor manufacturing technique is applied.

As shown in FIG. 4, the variable mirror 111 comprises an upper substrate 201, a lower substrate 221 placed opposite the upper substrate 201, and springs (elastic members) 251 to 254 each having opposite ends connected to the upper substrate 201 and lower substrate 221. The lower substrate 221 has a pivot (projecting portion) 261 that abuts against the substantial center of gravity of the upper substrate 201 to support the upper substrate 201. In the present example, the center of gravity of the upper substrate 201 almost corresponds to a central position of the upper substrate 201.

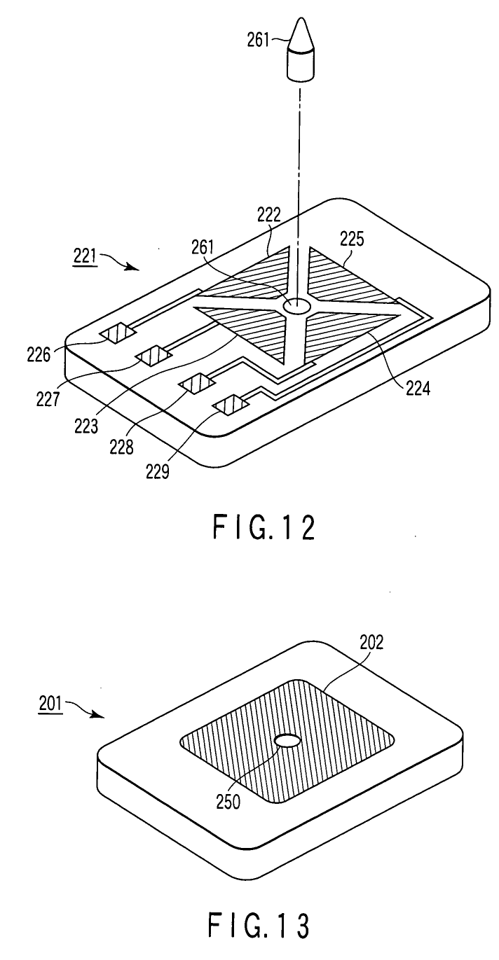

As shown in FIG. 12, in the present example, the pivot 261 is manufactured separately from the main body of the lower substrate 221. The pivot 261 is then bonded to the main body of the lower substrate 221. A tip portion of the pivot 261 is formed like a substantial sphere. Further, a concave portion 250 is formed in the substantial center of gravity (central position) of the upper substrate. That is, the concave portion 250 is formed at a position against which the tip of the pivot 261 abuts. A bottom portion of the concave portion 250 has a slightly larger curvature than the tip portion of the pivot 261.

As shown in FIG. 5A, the upper substrate 201 comprises an upper electrode 202 and an external lead electrode 203. The upper electrode 202 is separated and electrically insulated from the concave portion 250. A reflection portion 204 is provided on a surface of the upper substrate 201 which is located opposite the surface on which the upper electrode 202 is formed. The reflection portion 202 reflects and guides light from the subject to CCD. The upper electrode 202 is provided parallel to a reflection surface of the reflection portion 204 so as to be sandwiched between thin films 205. As shown in FIG. 5A, the upper electrode 202 is formed almost like a rectangle. The external lead electrode 203 is used to electrically connect the upper electrode 202 to an external component. A surface of the external lead electrode 203 is exposed.

In the lower substrate 221, the semiconductor substrate 230 is provided with four lower electrodes 222 to 225 and four external lead electrodes 226 to 229. The lower electrodes 222 to 225 are provided opposite the upper electrode 202 so that the lower electrodes 222 to 225 are substantially symmetric with respect to the pivot 261. The lower electrodes 222 to 225 are sandwiched between thin films 231 and separated and electrically insulated from the pivot 261. The external lead electrodes 226 to 229 are used to electrically connect the lower electrodes 222 to 225 to external components. Surfaces of the external lead electrodes 226 to 229 are exposed.

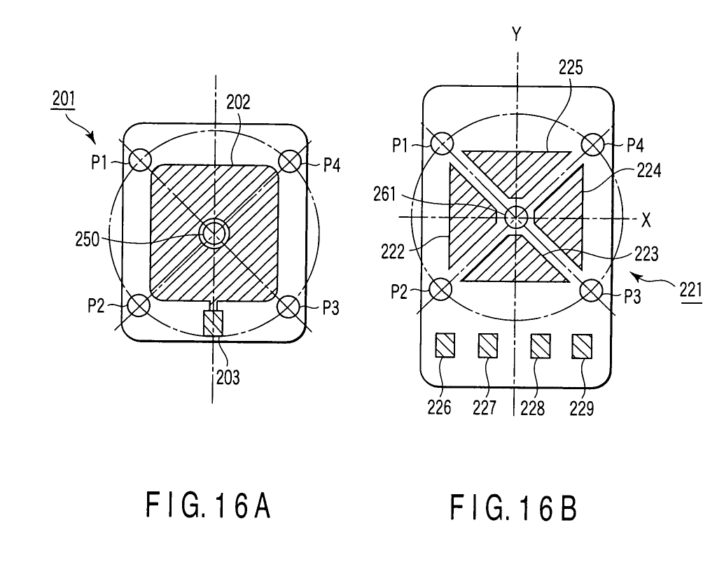

The four springs 251 to 254 are arranged between the upper substrate 201 and the lower substrate 221. The upper substrate 201 and the lower substrate 221 are connected together via the springs 251 to 254. The four springs 251 to 254 are arranged on substantially the same circumference at substantially equal intervals (periods of 90°). The pivot 261 is placed at a position corresponding to the center of the four springs 251 to 254, that is, the center of the four lower electrodes 222 to 225 (the intersecting point between an X axis and an Y axis in FIG. 5B). FIG. 16A is a diagram showing positions P1 to P4 at which the springs are arranged, with respect to the upper substrate 201. FIG. 16B is a diagram showing the positions P1 to P4 at which the springs are arranged, with respect to the lower substrate 221. The upper substrate 201 and the lower substrate 221 are pulled toward each other by the springs 251 to 254. The tensile force of the springs causes the pivot 261 to press the center of gravity of the upper electrode 201.

In the variable mirror 111 configured as described above, the tilt of the upper substrate 201 relative to the lower substrate 221 can be electrostatically varied by using the difference between a potential applied to the upper electrode 202 and a potential applied to each of the lower electrodes 222 to 225. This varies the tilt angle (reflection angle) of the reflection portion 204 (that is, varies the position (posture) of the reflection portion 204). Image blur can thus corrected by controlling the tilt angle.

In the example shown in FIGS. 4, 5A, and 5B, the upper electrode is composed of a single electrode, whereas the lower electrode is divided into a plurality of pieces. In contrast, the lower electrode may be composed of a single electrode, whereas the upper electrode may be divided into a plurality of pieces.

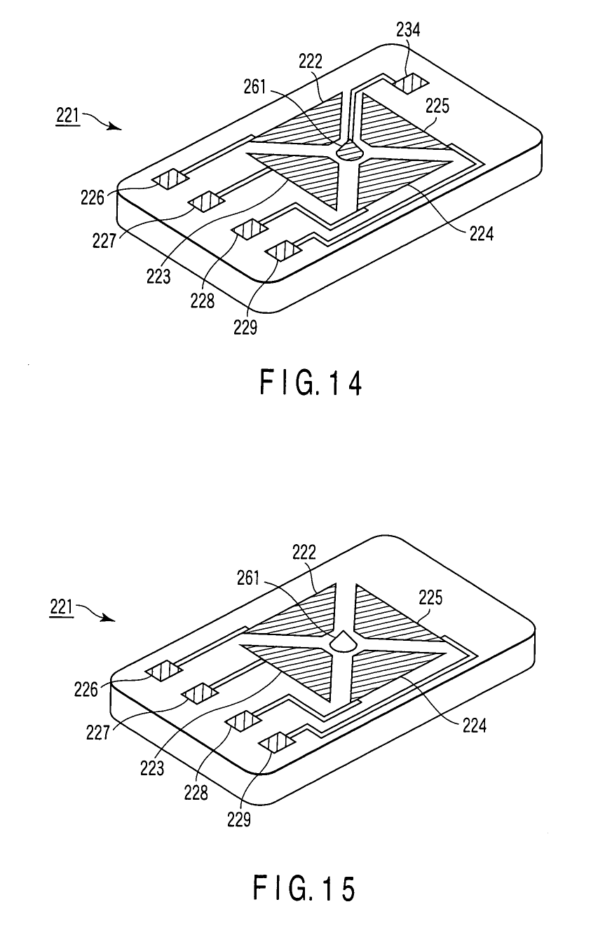

It is also possible to use a variation such as the one shown in FIGS. 13 and 14. In the present variation, as shown in FIG. 13, the upper electrode 202 is in electric communication with the concave portion 250. Further, as shown in FIG. 14, a lead electrode 234 is connected to the conductive pivot 261. This configuration enables the lead electrode 234 to supply a voltage to the upper electrode 202 via the pivot 261 and concave portion 250. That is, the potential of the upper electrode 202 becomes equal to that of the pivot 261. It is thus possible to omit a feeding line to the upper electrode 202. This makes it possible to prevent the degradation of controllability resulting from the spring property of the feeding line and to reduce costs.

Such a variation as shown in FIG. 15 can also be used. In the above example, the pivot 261 is manufactured separately from the main body of the lower substrate 221 and bonded to the substrate. However, in the present variation, a semiconductor manufacturing process or the like is used to form the pivot 261 integrally with the main body of the lower substrate 221. In this case, the curvature of the tip portion of the pivot 261 can be set at about several tens of nanometers by applying a process equivalent to that for a cantilever used in AFM (Atomic Force Microscope).

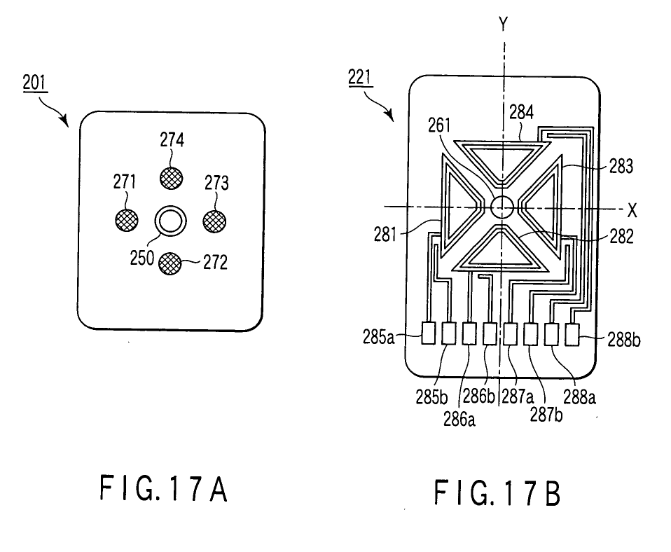

Furthermore, in the above example, the tilt of the upper electrode 201 relative to the lower substrate 221 is varied using the electrostatic force (attractive force) acting between the upper electrode 202 and the lower electrodes 222 to 225. However, the tilt may be varied using an electromagnetic force. FIGS. 17A and 17B are diagrams showing examples of the configurations of the upper substrate 201 and lower substrate 221, respectively, when electromagnetic force is used.

As shown in FIG. 17A, magnets 271 to 274 are provided on the upper substrate 201. As shown in FIG. 17B, coils 281 to 284 are provided on the lower substrate 221 at positions corresponding to the magnets 271 to 274. External lead electrodes 285a and 285b are connected to the opposite ends of the coil 281. External lead electrodes 286a and 286b are connected to the opposite ends of the coil 282. External lead electrodes 287a and 287b are connected to the opposite ends of the coil 283. External lead electrodes 288a and 288b are connected to the opposite ends of the coil 284. By controlling a current flowing through each coil, it is possible to vary the electromagnetic force (attractive force and repulsive force) exerted between the upper substrate 201 and the lower substrate 221. This enables the variation of the tilt of the upper substrate 201 relative to the lower substrate 221.

If the above variable mirror 111 is attached to a lens barrel (attached member) in an image capture apparatus, an attachment area 240 is provided on a surface of the lower substrate 221 which lies opposite the upper substrate 201, that is, the top surface of the lower substrate 221. The attachment area 240 is then tightly contacted with the lens barrel. As shown in FIGS. 4, 5A, and 5B, the lower substrate 221 has a larger area than the upper substrate 201. The lower substrate 221 thus has an area that does not overlap the upper electrode 201. Thus, the non-overlapping area can be partly used as the attachment area.

FIG. 6 is a diagram schematically showing how the above variable mirror 111 is attached to a lens barrel in an image capture apparatus. As shown in FIG. 6, the variable mirror 111 is fixed to a lens barrel 150 so that the top surface of the lower substrate 221 abuts against an outer surface of the lens barrel 150.

If the variable mirror 111 is attached to the lens barrel 150, what is important is the precision of position of the reflection portion (reflection surface) 204 of the variable mirror 111 with respect to the lens barrel 150. The upper substrate 201 of the variable mirror 111 is movable. Accordingly, if the upper substrate 201 is attached to the lens barrel 150, the variable mirror 111 cannot be appropriately controlled. Further, if the bottom surface of the lower substrate 221 is used for attachment, it is difficult to improve the precision of position of the reflection portion 204 of the variable mirror 111 owing to a variation (tolerance) in the thickness of the semiconductor substrate used for the lower substrate 221.

The present embodiment uses the top surface of the lower substrate 221 for attachment. This makes it possible to avoid the above problems and improve the positional precision of the reflection portion 204. Further, the attachment is carried out using the area of the lower substrate 221 which does not overlap the upper substrate 201. The variable mirror 111 can be is workably easily attached to the lens barrel 150.

The present embodiment provides the pivot 261, which abuts against the position of center of gravity of the upper substrate 201. Consequently, even with a variation in the tilt angle of reflection portion 204 of the variable mirror 111, a fixed distance is maintained between the lower substrate 221 and the center of gravity of the upper substrate 201. This enables a fixed optical path length to be maintained in a central portion. Therefore, the control of the focus or the like can be simplified without the need for considerations for a variation in optical path length.

### Second Embodiment

Now, description will be given of a second embodiment of the present invention. The basic configuration of the image capture apparatus shown in FIGS. 1 to 3, the principle of image blur correction, and the like are similar to those in the first embodiment. Accordingly, their description is omitted.

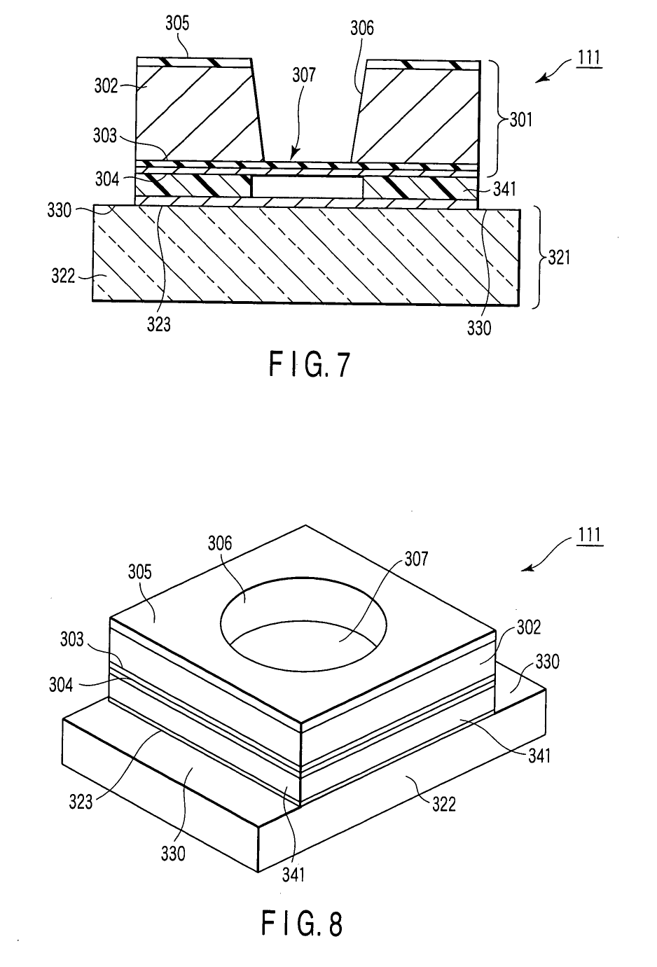

FIG. 7 is a sectional view showing an example of the configuration of the variable mirror 111 in accordance with the present embodiment. FIG. 8 is a perspective view showing an example of the configuration of the variable mirror 111 in accordance with the present embodiment. The variable mirror 111, shown in FIG. 7 and 8, is produced using the MEMS technique to which the semiconductor manufacturing technique is applied.

As shown in FIGS. 7 and 8, the variable mirror 111 comprises an upper substrate 301, a lower substrate 321 placed opposite the upper substrate 301, and a spacer member 341 placed between the upper substrate 301 and the lower substrate 321 to define a spacing (distance) between the upper substrate 301 and the lower substrate 321.

The upper substrate 301 has a silicon dioxide thin film (insulating thin film) 303 and a reflection film electrode 304 stacked on one principal surface of a silicon substrate (semiconductor substrate) 302 and a silicon dioxide thin film 305 formed on the other principal surface of the silicon substrate (semiconductor substrate) 302. A void 306 is formed in a central portion of the silicon substrate 302. Parts of the silicon dioxide thin film 303 and reflection film electrode 304 which correspond to the void 306 function as an effective reflection portion 307.

The lower substrate 321 has an opposite electrode 323 formed on an insulating substrate 322 such as glass and formed of a conductive thin film.

In the variable mirror 111 configured as described above, the reflection portion 307 is electrostatically deformed into a concave dented toward the opposite electrode 323 when there is a potential difference between the reflection film electrode 304 and the opposite electrode 323. Then, the displacement of the reflection portion 307 varies (that is, the shape of the reflection portion 307 varies) depending on the potential difference between the reflection film electrode 304 and the opposite electrode 323. This in turn varies the reflection angle of the reflection portion 307. Therefore, image blur can be corrected by controlling the displacement of the reflection portion 307.

If the above variable mirror 111 is attached to the lens barrel in the image capture apparatus, an attachment area 330 is provided on a surface of the lower substrate 321 which lies opposite the upper substrate 301, that is, the top surface of the lower substrate 321. The attachment area 330 is then tightly contacted with the lens barrel. As shown in FIGS. 7 and 8, the lower substrate 321 has a larger area than the upper substrate 301. The lower substrate 321 thus has an area that does not overlap the upper electrode 301. Thus, the non-overlapping area can be partly used as the attachment area.

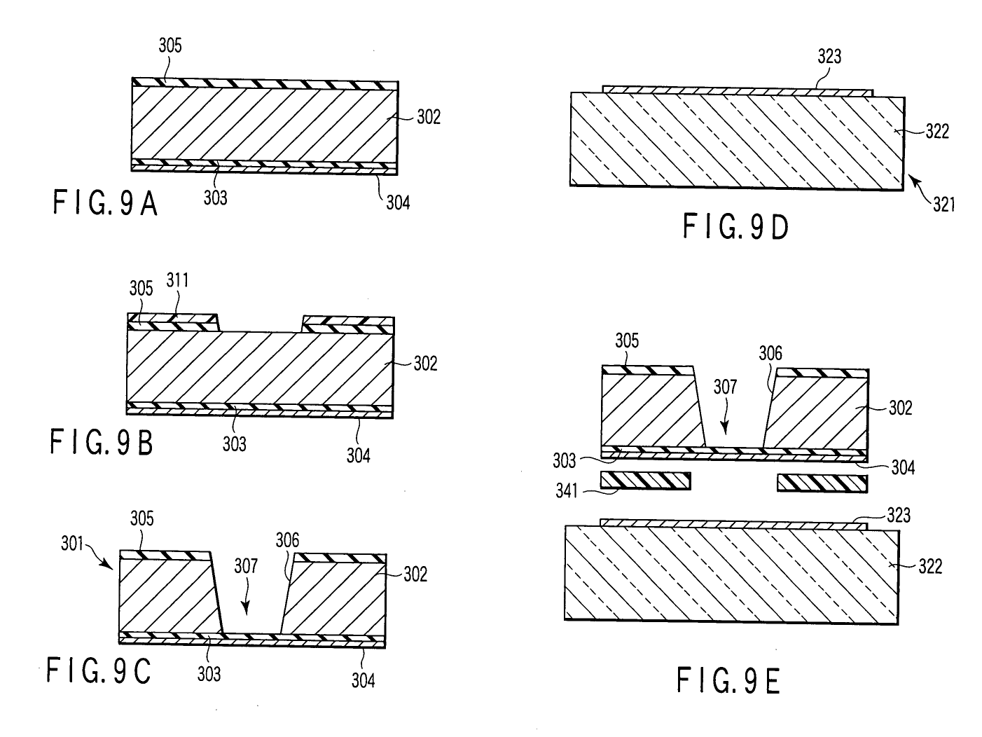

Now, with reference to FIGS. 9A to 9E, description will be given of a method for manufacturing the above variable mirror 111.

First, as shown in FIG. 9A, a silicon substrate (silicon wafer) 302 is provided which has mirror-polished opposite surfaces and a plane direction <100>. Silicon dioxide thin films 303 and 305 of thickness about 400 to 500 nm are formed on the respective surfaces of the silicon substrate 302. Subsequently, a gold thin film 304 of thickness about 100 nm is formed on the silicon dioxide thin film 303.

Then, as shown in FIG. 9B, a photo resist pattern 311 having a circular opening is formed on the silicon dioxide thin film 305. Subsequently, with the bottom surface of the substrate protected, the silicon dioxide thin film 305 is etched using the photo resist pattern 311 as a mask. A window corresponding to the opening in the photo resist pattern 311 is formed in the silicon dioxide thin film 305. For example, a fluoro acid-based etchant can be used for etching.

Then, as shown in FIG. 9C, the substrate is immersed into a water solution of ethylene diamine picatechol to etch the silicon substrate 302. The etching of the silicon substrate 302 starts from the window formed in the silicon dioxide thin film 305 and ends when the silicon dioxide thin film 303 is exposed. Thus, a void 306 is formed in the central portion of the silicon substrate 302. A reflection portion 307 is formed in the area corresponding to the void 306; the reflection portion 307 includes the silicon dioxide thin film 303 and the reflection film electrode 304. In this manner, the upper substrate 301 is obtained.

On the other hand, as shown in FIG. 9D, a glass substrate 322 of thickness about 300 μm is provided. An opposite electrode 323 is formed on the glass substrate 322; the opposite electrode 323 being formed of a metal film of thickness about 100 nm. In this manner, the lower substrate 321 is obtained.

After the upper substrate 301 and the lower substrate 321 are thus formed, the spacer member 341 is interposed between the upper substrate 301 and the lower substrate 321 as shown in FIG. 9E; the spacer member 341 is made of polyethylene and has a thickness of about 100 nm. The upper substrate 301 and the lower substrate 321 are then bonded together by the spacer member 341.

As described above, such a variable mirror 111 as shown in FIGS. 7 and 8 is produced.

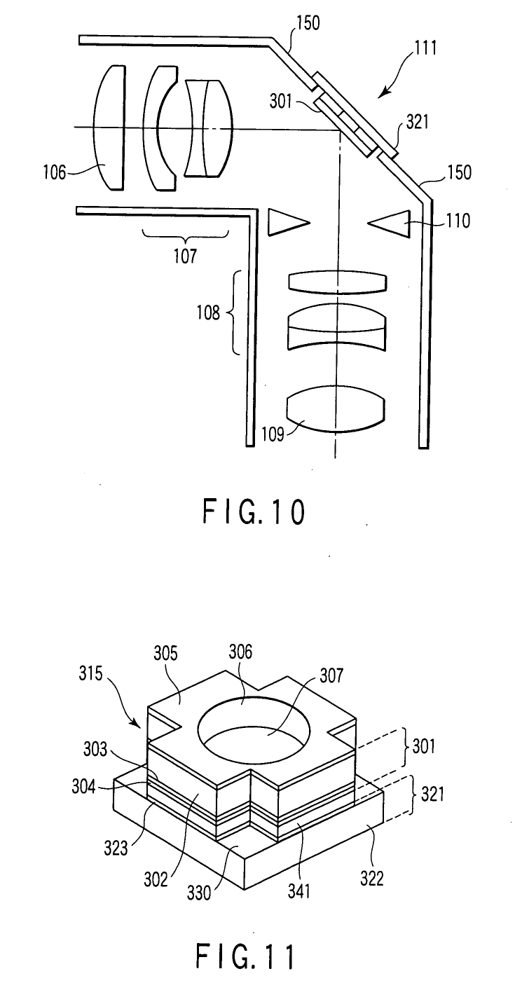

FIG. 10 is a diagram-schematically showing how the above variable mirror 111 is attached to the lens barrel in the image capture apparatus. As shown in FIG. 10, the variable mirror 111 is fixed to the lens barrel 150 so that the top surface of the lower substrate 321 abuts against the outer surface of the lens barrel 150.

As already described, if the variable mirror 111 is attached to the lens barrel 150, what is important is the precision of position of the reflection portion (reflection surface) 307 of the variable mirror 111 with respect to the lens barrel 150. If the upper substrate 301 is used for attachment, it is difficult to increase the positional precision of reflection portion 307 of the variable mirror 111 because of for example, a variation (tolerance) in the thickness of the semiconductor substrate used as the upper substrate 301 or warpage that may occur during a manufacturing process. On the other hand, if the bottom surface of the lower substrate 321 is used for attachment, it is also difficult to increase the positional precision of reflection portion 307 of the variable mirror 111 because of for example, a variation in the thickness of the lower substrate 321.

In contrast, if the top surface of the lower substrate 321 is used for attachment, it is possible to very precisely manage the spacing between the top surface of the lower substrate 321 and the bottom surface of the upper substrate 301 by using a member with a high dimensional precision (for example, precisely formed glass beads) as the spacer member 341. Further, the glass substrate used as the lower substrate 321 generally has a high flatness. The positional precision of the reflection portion 307 can thus be increased by using the top surface of the lower substrate 321 for attachment as in the present embodiment. According to the present embodiment, as in the case of the first embodiment, the attachment is carried out using the area of the lower substrate 321 which does not overlap the upper electrode 301. Therefore, the variable mirror 111 can be workably easily attached to the lens barrel 150.

FIG. 11 is a perspective view showing another example of configuration of the variable mirror 111 in accordance with the present embodiment. In the example shown in FIGS. 7 and 8, the attachment area 330 is provided at the opposite ends of the lower substrate 321. However, in the present example, the attachment area 330 is provided in the four corners of the lower substrate 321. That is, notch portions 315 are formed in the four corners of the upper substrate 301, and the attachment areas 330 are provided in association with the notch portions 315. The notch portions 315 can be formed by etching away the four corners of the upper substrate 301 before or after the upper substrate 301 is laminated to the lower substrate 321.

The use of such a configuration as shown in FIG. 11 also makes it possible to exert effects similar to those of the example shown in FIGS. 7 and 8. The size of the lower substrate 321 can be reduced by forming notch portions 315 and providing the attachment areas 330 in association with the notch portions 315.

What is claimed is:

1. A variable mirror comprising a first substrate having a reflection portion which reflects light and a second substrate located opposite the first substrate and having a part used to vary at least one of a shape and a position of the reflection portion,
wherein the second substrate has an attachment area on a surface of the second substrate, which is located opposite the first substrate.

2. The variable mirror according to claim 1, wherein the attachment area is provided in an area in which the second substrate does not overlap the first substrate.

3. The variable mirror according to claim 1, wherein the second substrate,has a larger area than the first substrate.

4. The variable mirror according to claim 1, wherein the first substrate has a notch portion, and the attachment area is provided in an area corresponding to the notch portion.

5. The variable mirror according to claim 4, wherein the notch portion is formed by etching.

6. The variable mirror according to claim 1, further comprising a support member provided between the first substrate and the second substrate to support the first substrate.

7. A variable mirror comprising a first substrate having a reflection portion which reflects light and a second substrate located opposite the first substrate, the variable mirror being configured so that the first substrate and the second substrate interact with each other,
wherein the second substrate has a projecting portion on a surface of the second substrate, which is located opposite the first substrate.

8. The variable mirror according to claim 7, wherein the interaction is an attractive force exerted between the first substrate and the second substrate.

9. The variable mirror according to claim 7, wherein the interaction is a repulsive force exerted between the first substrate and the second substrate.

10. The variable mirror according to claim 7, wherein the projecting portion is integrated with a main body of the second substrate.

11. The variable mirror according to claim 7, wherein the projecting portion adheres to the second substrate.

12. The variable mirror according to claim 7, wherein the projecting portion abuts against the first substrate in a substantial center of gravity of the first substrate.

13. The variable mirror according to claim 7, wherein the projecting portion abuts against the first substrate in a substantial center of the first substrate.

14. The variable mirror according to claim 7, wherein a tip of the projecting portion is spherical.

15. The variable mirror according to claim 7, wherein the first substrate has a concave portion at a position against which the projecting portion abuts.

16. The variable mirror according to claim 15, wherein the concave portion is formed in a substantial center of gravity of the first substrate.

17. The variable mirror according to claim 15, wherein the concave portion is formed in a substantial center of the first substrate.

18. The variable mirror according to claim 7, wherein the second substrate has an electrode which causes the interaction, and the electrode is separated from the projecting portion.

19. The variable mirror according to claim 7, wherein the first substrate has an electrode which causes the interaction, and the electrode has the same electrical potential as that of the projecting portion.

20. The variable mirror according to claim 7, wherein the first substrate has an electrode which causes the interaction, and the electrode is electrically insulated from the projecting portion.

21. The variable mirror according to claim 7, further comprising an elastic member having one end connected to the first substrate and the other end connected to the second substrate.

22. The variable mirror according to claim 21, wherein a plurality of the elastic members are provided between the first substrate and the second substrate.

23. The variable mirror according to claim 22, wherein distances between the projecting portion and the elastic members are equal.

24. The variable mirror according to claim 22, wherein the plurality of elastic members are arranged at substantially equal intervals on a circle drawn around the projecting portion.

25. The variable mirror according to claim 21, wherein the elastic member is a spring.

26. The variable mirror according to claim 25, wherein the spring causes the first substrate and the second substrate to pull each other.
